(19) United States
(12) Patent Application Publication
(10) Pub. No.: US 2017/0099693 A1
(43) Pub. Date: Apr. 6, 2017

(54) METHOD OF MEASUREMENT ENHANCEMENT ON TURNED-OFF SMALL CELL FOR DUAL CONNECTIVITY

(71) Applicant: ALCATEL LUCENT, Boulogne-Billancourt (FR)

(72) Inventors: Yun Deng, Shanghai (CN); Chandrika Worrall, Newbury (GB)

(73) Assignee: Alcatel Lucent, Boulogne Billancourt (FR)

(21) Appl. No.: 15/127,804

(22) PCT Filed: Mar. 17, 2015
(86) PCT No.: PCT/IB2015/000631

§ 371 Date: Sep. 21, 2016

(30) Foreign Application Priority Data
Mar. 21, 2014 (CN) 201410109778.6

(51) Int. Cl. H04W 76/02; H04W 48/16; H04W 24/10

(52) U.S. Cl. CPC H04W 76/025; H04W 24/10; H04W 48/16

(57) ABSTRACT

The invention discloses a method, at a primary e NB, of measurement enhancement on a turned-off small cell for dual connectivity, the method including: obtaining OFF-status information of the turned-off small cell from a secondary e NB; transmitting the OFF-status information to a UE; receiving a measurement report transmitted from the UE about the turned-off small cell; deciding to configure the UE with the dual connectivity; transmitting a request to the secondary e NB to set up the dual connectivity; and receiving an acknowledgement command of the secondary e NB, wherein when the acknowledgement command includes an acknowledgement of the secondary e NB for accepting setting up of the dual connectivity, the method further includes: transmitting RRC connection reconfiguration information to the UE, so that the UE accesses the secondary e NB and sets up the dual connectivity according to the reconfiguration information.

### FIELD OF THE INVENTION

The present disclosure generally relates to the field of wireless communications and particularly to a method of measurement enhancement on a turned-off small cell for dual connectivity of a User Equipment (UE) with the small cell.

### BACKGROUND OF THE INVENTION

Dual connectivity refers to a process where a given UE in the RRC_CONNECTED (Radio Resource Control Connected) accesses radio resources provided by at least two different network nodes (e.g., a primary eNB and a secondary eNB) connected by a non-ideal backhaul. Usually the primary eNB has large coverage and the secondary eNB has small coverage. The secondary eNB may turn off some serving small cells served by the secondary eNB to save power or lower interference. The RAN1 has reached the following agreements about turning on/off a small cell (according to R1-141021): For intra-/inter-frequency RRM (Radio Resource Management) measurements, at least DRS (Discovery Reference Signal)-based RSRP (Reference Signal Received Power) measurements are supported;

For RRM measurements, support DRS-based RSRQ (Reference Signal Received Quality)-like measurements are supported;

Network assistance related to at least timing information associated with a discovery measurement is provided to a UE for the Rel-12 discovery procedure.

However there are still some open issues for a discovery of a turned-off small cell in the prior art, for example:

How to provide a UE with particular network assistance or information to perform an enhanced cell discovery;

Whether (or how) to accurately notify the UE of information about the turned-on/off status of the small cell; and

Which other signal(s) available to the UE can be discovered in addition to a PSS (Primary Synchronization Signal) for an enhanced cell discovery.

There is no solution in the prior art to the technical problem above because the small cell is typically turned on. Moreover even if the small cell is turned off, there is still no technical solution in the prior art to how to require the UE to measure the turned-off small cell.

In order to deal with these issues, this application provides in details a method of measurement enhancement on the turned-off small cell. Moreover this application provides a detailed procedure to configure the UE for dual connectivity when the small cell is turned off.

### SUMMARY OF THE INVENTION

In order to address the technical problem above, according to an aspect of the invention, there is disclosed a method, at a primary eNB, of measurement enhancement on a turned-off small cell for dual connectivity, the method including the steps of: obtaining OFF-status information of the turned-off small cell from a secondary eNB; transmitting the OFF-status information to a UE; receiving a measurement report transmitted from the UE about the turned-off small cell; deciding to configure the UE with the dual connectivity; transmitting a request to the secondary eNB to set up the dual connectivity; and receiving an acknowledgement command of the secondary eNB, wherein when the acknowledgement command includes an acknowledgement of the secondary eNB for accepting setting up of the dual connectivity, the method further includes the step of: transmitting RRC connection reconfiguration information to the UE, so that the UE accesses the secondary eNB and sets up the dual connectivity according to the reconfiguration information.

Particularly the turned-off small cell transmits intermittently a Discovery Reference Signal (DRS); and the OFF-status information includes a transmission interval of the Discovery Reference Signal (DRS).

Particularly when a macro cell served by the primary eNB is not synchronized with the turned-off small cell, the OFF-status information further includes a difference in synchronization between the macro cell and the turned-off small cell.

Particularly the OFF-status information further includes a sub-frame number in which the Discovery Reference Signal (DRS) is transmitted from the turned-off small cell, or a radio frame number and a sub-frame number in which the Discovery Reference Signal (DRS) is transmitted from the turned-off small cell; and when the Discovery Reference Signal (DRS) transmitted from the turned-off small cell is not a Cell-specific Reference Signal (CRS), the OFF-status information further includes a type of the Discovery Reference Signal (DRS).

Particularly the primary eNB obtains the OFF-status information from the secondary eNB in any one of: i. an X2 Setup Request; ii. an X2 Setup Response; and iii. an eNB configuration update; and the primary eNB transmits the OFF-status information to the UE in measurement configuration information including a measurement object which refers to a frequency where the turned-off small cell operates and which includes the OFF-status information.

According to another aspect of the invention, there is disclosed a method, at a secondary eNB, of measurement enhancement on a turned-off small cell for dual connectivity, the method including the steps of: transmitting OFF-status information of the served turned-off small cell to a primary eNB; receiving a request transmitted from the primary eNB to set up the dual connectivity; and deciding whether to accept the setting up of the dual connectivity, wherein when the setting up of the dual connectivity is accepted: I. transmitting an acknowledgement command to the primary eNB, the acknowledgement command including configuration information required for a UE to set up the dual connectivity, and II. transmitting uplink and downlink data with the UE over the setup dual connectivity; and when the setting up of the dual connectivity is not accepted, transmitting a failure response to the primary eNB.

Particularly the turned-off small cell transmits intermittently a Discovery Reference Signal (DRS); and the OFF-status information includes a transmission interval of the Discovery Reference Signal (DRS).

Particularly when a macro cell served by the primary eNB is not synchronized with the turned-off small cell, the OFF-status information further includes a difference in synchronization between the macro cell and the turned-off small cell.

Particularly the OFF-status information further includes a sub-frame number in which the Discovery Reference Signal (DRS) is transmitted from the turned-off small cell, or a radio frame number and a sub-frame number in which the Discovery Reference Signal (DRS) is transmitted from the turned-off small cell; and when the Discovery Reference Signal (DRS) transmitted from the turned-off small cell is not a Cell-specific Reference Signal (CRS), the OFF-status information further includes a type of the Discovery Reference Signal (DRS).

Particularly the turned-off small cell is a special small cell which refers to a small cell configuring the UE with a PUCCH channel, and when the special small cell is turned off, the step II includes: when there is downlink data to transmit to the UE: A. turning on the turned-off small cell and transmitting periodically physical layer control signaling to the UE, and B. transmitting the downlink data to the UE; when there is uplink data to receive from the UE, receiving the uplink data of the UE in a random access procedure initiated by the UE over a random access resource configured by the small cell.

According to still another aspect of the invention, there is disclosed a method, at a UE, of measurement enhancement on a turned-off small cell for dual connectivity, the method including the steps of: a. setting up an RRC connection with a primary eNB; b. receiving OFF-status information of the turned-off small cell from the primary eNB; c. measuring a quality of signal of the turned-off small cell based upon the OFF-status information; d. transmitting a measurement report about the turned-off small cell to the primary eNB; e. receiving RRC connection reconfiguration information from the primary eNB; f. reconfiguring the RRC connection according to the RRC connection reconfiguration information to set up the dual connectivity; and g. transmitting uplink and downlink data with a secondary eNB serving the small cell over the setup dual connectivity.

Particularly the turned-off small cell transmits intermittently a Discovery Reference Signal (DRS), and the OFF-status information includes a transmission interval of the Discovery Reference Signal (DRS); and when a macro cell served by the primary eNB is not synchronized with the turned-off small cell, the OFF-status information further includes a difference in synchronization between the macro cell and the turned-off small cell.

Particularly the OFF-status information further includes a sub-frame number in which the Discovery Reference Signal (DRS) is transmitted from the turned-off small cell, or a radio frame number and a sub-frame number in which the Discovery Reference Signal (DRS) is transmitted from the turned-off small cell; and when the Discovery Reference Signal (DRS) transmitted from the turned-off small cell is not a Cell-specific Reference Signal (CRS), the OFF-status information further includes a type of the Discovery Reference Signal (DRS).

Particularly the turned-off small cell is a special small cell which refers to a small cell configuring the UE with a PUCCH channel, and when the special small cell is turned off, the step g includes: detecting periodically physical layer control signaling from the special small cell, and when the physical layer control signaling is determined to be valid, receiving downlink data transmitted from the secondary eNB; and when there is uplink data to transmit to the secondary eNB, initiating a random access procedure to the secondary eNB over the setup dual connectivity to transmit the uplink data.

According to a further aspect of the invention, there is disclosed a method, at a UE, of measurement enhancement on a turned-off small cell, the method including the steps of: receiving measurement configuration information transmitted from an eNB, wherein the measurement configuration information includes at least a transmission interval of a Discovery Reference Signal (DRS) transmitted from the turned-off small cell; measuring and evaluating a quality of signal in the turned-off small cell according to the measurement configuration information; and when the quality of signal satisfies a report condition, transmitting a measurement report to the eNB about the turned-off small cell.

The invention provides a method of discovering a turned-off small cell through the disclosed measurement enhancement, and the method provides the UE with necessary information to discover the small cell and also provides the UE with optimized information to save power in the measurement procedure.

### BRIEF DESCRIPTION OF DRAWINGS

The foregoing and other features of the invention will become more apparent from the following detailed description of the embodiments taken in conjunction with the drawings, and identical or like reference numerals in the drawings denote identical or like steps. In the drawings:

FIG. 1 illustrates a schematic diagram of a method of measurement enhancement on a turned-off small cell for dual connectivity according to an embodiment of the invention;

FIG. 2 illustrates a schematic diagram of frame signals of a macro cell and a small cell when frame signals are synchronized;

FIG. 3 illustrates a schematic diagram of frame signals of the macro cell and the small cell when the frame signals are not synchronized; and

FIG. 4 illustrates a flow chart of a method, at a UE, of measurement enhancement on a turned-off small cell.

### DETAILED DESCRIPTION OF EMBODIMENTS

Reference will be made to the drawings, which constitute a part of the invention, in the following detailed description of preferred embodiments. The drawings exemplarily illustrate particular embodiments in which the invention can be embodied. The exemplary embodiments are not intended to exhaust all the embodiments of the invention. It shall be noted that although the steps of the method in the invention are described in a particular order, this will not require or suggest that these operations be performed in the particular order or all the illustrated operations must be performed for a desirable result, but on the contrary, the steps described in this context can be performed in an alternative order. Additionally or alternatively some of the steps can be omitted, more than one of the steps can be combined into one step and/or one of the steps can be decomposed into more than one step.

Dual connectivity refers to transmitting uplink and downlink data with a UE through both a primary eNB and a secondary eNB, where the UE needs to maintain a high quality of communication with the primary eNB and the secondary eNB, so it is of great importance to determine a quality of signal between the UE and the primary eNB and secondary eNB before dual connectivity is set up. Typically the primary eNB has a large signal coverage area with high signal strength and high stability; whereas the secondary eNB has a small signal coverage with lower signal strength than the primary eNB, so it is necessary to measure a signal in a small cell served by the secondary eNB to judge whether the UE can perform dual connectivity in the small cell. If the UE measures a high quality of signal in the small cell, then it indicates that the UE can maintain a high quality of communication with the secondary eNB serving the small cell, that is, the UE can perform dual connectivity with the secondary eNB; otherwise, it indicates impossible dual connectivity.

Typically when the small cell served by the secondary eNB is turned on and the UE is configured with corresponding measurement configuration information (e.g., a measurement identity about the small cell, etc.), the UE can detect and measure the quality of signal in the cell based upon a PSS/SSS/CRS (Primary Synchronization Signal/Secondary Synchronization Signal/Cell-Specific Reference signal) of the small cell.

When the small cell served by the secondary eNB is turned off, the UE can only measure a Discovery Reference Signal (DRS) of the small cell to determine the quality of signal in the small cell. In order to accurately measure the Discovery Reference Signal (DRS), the UE has to obtain necessary information about the Discovery Reference Signal (DRS).

There has been unknown in the prior art as to how the UE obtains the necessary information about the Discovery Reference Signal (DRS), which information is the necessary information about the Discovery Reference Signal (DRS) and how the UE accurately measures the quality of signal in the turned-off small cell and sets up dual connectivity. In view of the technical problem, this application provides the following solutions to the technical problem above.

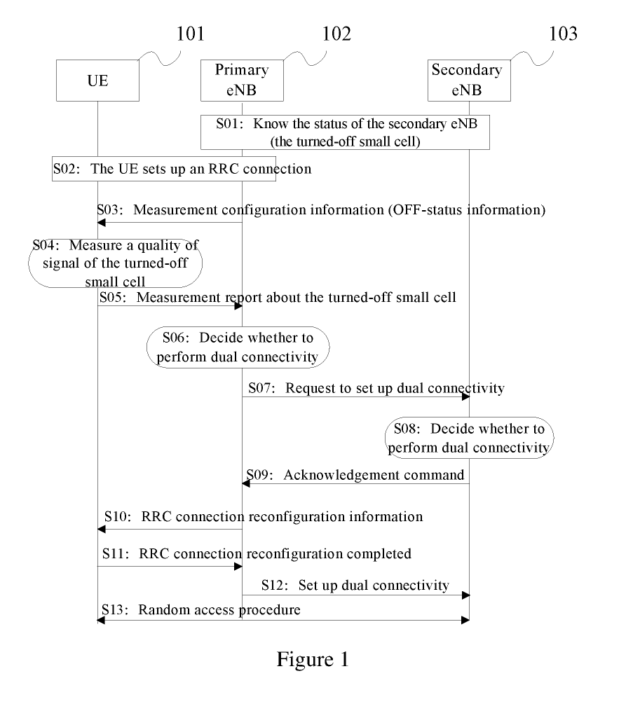

FIG. 1 illustrates a schematic diagram of a method of measurement enhancement on a turned-off small cell for dual connectivity according to an embodiment of the invention.

In the embodiment of the invention, a UE 101 is a UE measuring a turned-off small cell; a primary eNB 102 is responsible for serving a macro cell where the UE 101 is located; and a secondary eNB 103 is responsible for serving the turned-off small cell, and the turned-off small cell served by the secondary eNB 103 can be one or more cells. For the sake of conciseness, the cell in a turned-off status will be referred simply to as a turned-off small cell hereinafter. A Discovery Reference Signal (DRS) will be referred simply to as a DRS, and a Cell-specific Reference Signal (CRS) will be referred simply to as a CRS.

In the step S01, the primary eNB 102 obtains OFF-status information of the turned-off small cell from the secondary eNB 103. The OFF-status information can be retrieved by the primary eNB 102 requesting from the secondary eNB 103, or can be transmitted from the secondary eNB 103 actively to the primary eNB 102.

In a preferred embodiment, when the small cell enters from the turned-on status to the turned-off status, the secondary eNB 103 transmits the OFF-status information actively to the primary eNB 102.

In another preferred embodiment, the primary eNB 102 obtains the OFF-status information via X2 interface signaling, e.g., an X2 Setup Request, an X2 Setup Response or an eNB configuration update.

The OFF-status information will be transported to the UE 101 in the step S03 to enable the UE 101 to measure a quality of signal of the turned-off small cell based upon the information. In order to enable the UE 101 to accurately measure the quality of signal of the turned-off small cell, the OFF-status information shall include necessary information related to timing of a DRS.

In the embodiment of the invention, the OFF-status information includes at least a transmission interval of the DRS.

The turned-off small cell will transmit intermittently the DRS. When the UE 101 attempts to detect the quality of signal in the small cell, it will obtain synchronization information of the small cell. Once the UE 101 detects and measures the DRS according to the synchronization information, it will measure again the next DRS for a further measurement sample. If the UE 101 has no knowledge of the transmission interval of the DRS at this time, then the UE 101 may select another sub-frame without any DRS to measure, which may result in an error of a measurement result, so the UE 101 shall be notified of at least the transmission interval of the DRS. This means that the OFF-status information includes at least the transmission interval of the DRS. The transmission interval of the DRS corresponds to the small cell, and DRS transmission intervals of different small cells may be different, so the DRS transmission intervals of the different small cells are specific.

In the embodiment of the invention, when the DRS transmitted from the turned-off small cell is not a CRS, the OFF-status information further includes the type of the DRS.

Typically when the UE detects or measures a cell, it will obtain synchronization information of the cell and then detect a CRS of the cell. The CRS is typically transmitted in each sub-frame of the eNB. If the DRS is consistent with the CRS, then the OFF-status information will not include information about the type of the DRS; but if the DRS is not the CRS, then information about the type of the DRS (e.g., a CSIRS (Channel Status Information-Reference Signal)) or a PRS (Position Reference Signal) shall be provided by the primary eNB 102 to the UE 101 in the OFF-status information.

In the embodiment of the invention, the OFF-status information can further include the number of a sub-frame in which the DRS is transmitted from the turned-off small cell, or the number of a radio frame and the number of a sub-frame in which the DRS is transmitted from the turned-off small cell.

Although the UE 101 can automatically detect the first sub-frame, including the DRS, transmitted from the turned-off small cell. However if the UE 101 is notified of the number of the sub-frame in which the DRS is transmitted from the turned-off small cell, or the number of the radio frame and the number of the sub-frame in which the DRS is transmitted from the turned-off small cell, then the UE 101 may not spend additional power on automatic detection to thereby save power of the UE.

In the embodiment of the invention, when a macro cell served by the primary eNB 102 is not synchronized with the turned-off small cell served by the secondary eNB 103, the OFF-status information further includes the difference in synchronization between the macro cell and the turned-off small cell.

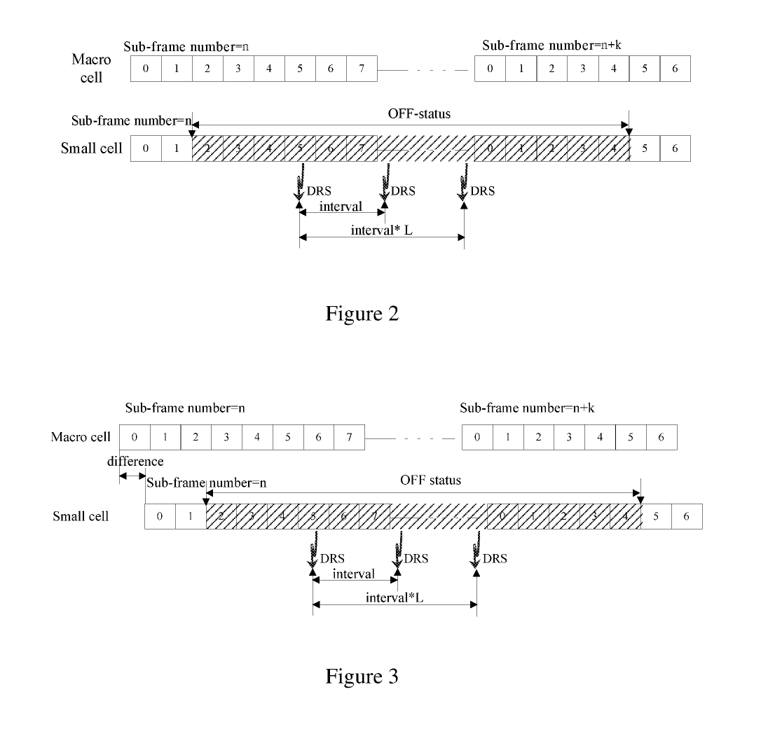

FIG. 2 illustrates a schematic diagram of frame signals of the macro cell and the small cell when the frame signals are synchronized. As illustrated in FIG. 2, the frame signals of the macro cell and the small cell are synchronized, and L DRS's are transmitted at a fixed interval in the small cell being turned off (shadowed in the figure). Since the macro cell is synchronized with the small cell, the UE 101 can accurately know the synchronization information of the turned-off small cell as long as the primary eNB 102 provides the UE 101 with synchronization information of the macro cell.

FIG. 3 illustrates a schematic diagram of frame signals of the macro cell and the small cell when the frame signals are not synchronized. As illustrated in FIG. 3, there is a difference between the frame signal of the macro cell and the frame signal of the small cell, and since the macro cell is not synchronized with the small cell, and a synchronization information may not be transmitted from the turned-off small cell, the UE 101 has no knowledge of the synchronization information of the turned-off small cell. Thus when the macro cell served by the primary eNB 102 is not synchronized with the turned-off cell served by the secondary eNB 103, the OFF-status information shall further include the difference in synchronization between the macro cell and the turned-off small cell, so that the UE can accurately derive the synchronization information of the small cell after obtaining the synchronization information of the primary eNB and the difference. Thus if the turned-off small cell transmits a synchronization signal, then the UE 101 can detect the synchronization information of the turned-off small cell without being provided with the difference in synchronization. If the turned-off small cell does not transmit any synchronization signal, and there is a different in synchronization between the frame signals of the macro cell and the small cell, then the UE shall obtain the difference in synchronization.

In the step S02, the UE 101 sets up a Radio Resource Control (RRC) connection with the primary eNB 102, so that the UE 101 transmits uplink and downlink data with the primary eNB 102.

In the step S03, after the UE 101 sets up the RRC connection with the primary eNB 102, the primary eNB 102 transmits measurement configuration information including the OFF-status information to the UE 101. The measurement configuration information includes a measurement identity and the OFF-status information corresponding to the measurement identity. Each measurement identity corresponds to a measurement object, where the measurement object refers to a frequency at which the turned-off small cell operates, and the measurement object further includes other configuration of respective adjacent cells at the frequency (adjacent cells to the macro cell, including the turned-off small cell), e.g., whether an antenna port 1 is accessed by these adjacent cells, frequency offsets, the identifiers of physical cells of the adjacent cells, etc. Particularly in this embodiment, the measurement object includes the OFF-status information of the turned-off small cell.

In the step S04, the UE 101 measures a quality of signal of the turned-off small cell based upon the OFF-status information in the measurement configuration information. The turned-off small cell will transmit intermittently the DRS. The UE 101 obtains synchronization information of the turned-off small cell from the obtained OFF-status information or detects automatically the synchronization information of the small cell, and detects the location of the DRS in the sub-frame. The UE 101 evaluates a quality of signal of the detected DRS, and when the measured quality of signal satisfies a report condition (the report condition can be that the quality of signal of the turned-off small cell keeps on being a preset threshold for a period of time), the flow proceeds to the step S05 where the UE 101 transmits a measurement report about the quality of signal in the turned-off small cell to the primary eNB 102.

In the step S06, the primary eNB 102 decides whether to perform dual connectivity for the UE 101 according to the measurement report received from the UE 101 about the quality of signal of the turned-off small cell. If the primary eNB 102 decides to perform dual connectivity, then the primary eNB 102 transmits a request to the secondary eNB 103 to set up dual connectivity in the step S07. A particular request to set up dual connectivity can be indication signaling added by the secondary eNB, and the exact name of the signaling will not be defined in this application.

In the step S08, the secondary eNB 103 judges whether to perform dual connectivity upon reception of the request to set up dual connectivity, and if the secondary eNB 103 accepts setting up of dual connectivity, then the secondary eNB 103 returns an acknowledgement command, and also turns on the small cell to enable it to operate normally, in the step S09. If the secondary eNB 103 does not accept setting up of the dual connectivity, then the secondary eNB 103 transmits a failure response to the primary eNB 102.

In the step S09, the secondary eNB transmits an acknowledgement command to the primary eNB 102. The acknowledgement command includes configuration information required for the UE 101 to set up dual connectivity (e.g., configuration information of a small cell accessed by the UE 101, etc.) and an acknowledge message of the secondary eNB 103 for accepting setting up of dual connectivity.

In the step S10, the primary eNB 102 generates RRC connection reconfiguration information for the UE 101 to set up dual connectivity based upon the configuration information in the received acknowledgment command, and transmits the RRC connection reconfiguration information to the UE 101.

In the step S11, the UE 101 reconfigures the RRC connection according to the received RRC connection reconfiguration information to enable dual connectivity of the UE 101 with the primary eNB 102 and the secondary eNB 103. Thereafter the UE 101 feeds a message back to the secondary eNB 103 to indicate that the UE has completed reconfiguration of the RRC connection.

In the step S13, the UE 101 can access the small cell in a random access procedure based upon the configuration information to transmit uplink and downlink data with the secondary eNB 103 to thereby enable dual connectivity of the UE with the macro cell and the turned-off small cell. At this time the turned-off small cell has being operating normally.

When the turned-off small cell served by the secondary eNB 103 in the case above is a special small cell, that is, the turned-off small cell is a small cell configuring a PUCCH channel for the UE, if the turned-off small cell can be switched rapidly, then this will be important particularly for the UE, which has set up dual connectivity, to perform efficiently dual connectivity.

According to an embodiment of the invention, the UE 101 detects periodically physical layer control signaling from the special small cell, and when the physical layer control signaling is determined to be valid, it means that the special small cell is turned on and has downlink data to transmit to the UE 101, so the UE 101 transmits data with the secondary eNB 103 and receives downlink data transmitted from the small cell. When the UE 101 has uplink data to transmit to the particular small cell which is still turned off, then the UE 101 can initiate a random access procedure to the secondary eNB over the set-up dual connectivity to transmit the uplink data, where the random access resource is configured by the small cell for the UE 101 in the steps S09 and S10. The random access configuration requires the secondary eNB 103 to be awaked occasionally to receive a potential preamble from the UE.

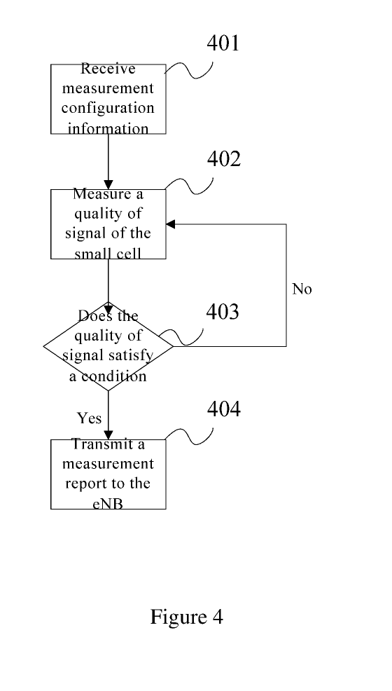

Moreover following the technical disclosure of S01 to S05, an embodiment of the invention can further provide a method, at a UE, of measurement enhancement on a turned-off small cell. FIG. 4 illustrates a flow chart of a method, at a UE, of measurement enhancement on a turned-off small cell.

In the step 401, the UE receives measurement configuration information transmitted from an eNB, where the measurement configuration information includes at least a transmission interval of a Discovery Reference Signal (DRS) transmitted from the turned-off small cell;

In the step 402, the UE measures and evaluates a quality of signal of the turned-off small cell according to the measurement configuration information; and

In the step 403, the UE evaluates a measurement result, and when the quality of signal satisfies a report condition, the flow proceeds to the step 404 where the UE transmits a measurement report to the eNB about the turned-off small cell; or when the quality of signal does not satisfy the report condition, the step 402 is repeated to measure the quality of signal in the small cell.

Where the measurement configuration information includes OFF-status information of the turned-off small cell. Reference can be made to the description above of the step S01 for details of the OFF-status information, so a repeated description thereof will be omitted here.

Those skilled in the art shall appreciate that evidently the invention will not be limited to the exemplary embodiments above, but the invention can be embodied in other particular forms without departing from the spirit or essence of the invention. Accordingly the embodiments shall be constructed in any way to be exemplary and non-limiting. Moreover apparently the term “comprise” will not preclude other elements and steps, and the term “a/an” will not preclude plural. More than one element stated in the device claim can be embodied as one element. The terms “first”, “second”, etc., are intended to dominate the elements in question but not to suggest any particular order thereof.

1. A method, at a primary eNB, of measurement enhancement on a turned-off small cell for dual connectivity, the method comprising:
obtaining OFF-status information of the turned-off small cell from a secondary eNB;
transmitting the OFF-status information to a UE;
receiving a measurement report transmitted from the UE about the turned-off small cell;
deciding to configure the UE with the dual connectivity;
transmitting a request to the secondary eNB to set up the dual connectivity; and
receiving an acknowledgement command of the secondary eNB, wherein when the acknowledgement command comprises an acknowledgement of the secondary eNB for accepting setting up of the dual connectivity, the method further comprises:
transmitting RRC connection reconfiguration information to the UE, so that the UE accesses the secondary eNB and sets up the dual connectivity according to the reconfiguration information.

2. The method according to claim 1, wherein the turned-off small cell transmits intermittently a Discovery Reference Signal; and
the OFF-status information comprises a transmission interval of the Discovery Reference Signal.

3. The method according to claim 2, wherein when a macro cell served by the primary eNB is not synchronized with the turned-off small cell, the OFF-status information further comprises a difference in synchronization between the macro cell and the turned-off small cell.

4. The method according to claim 1, wherein:
the OFF-status information further comprises a sub-frame number in which the Discovery Reference Signal is transmitted from the turned-off small cell, or a radio frame number and a sub-frame number in which the Discovery Reference Signal is transmitted from the turned-off small cell; and
when the Discovery Reference Signal transmitted from the turned-off small cell is not a Cell-specific Reference Signal, the OFF-status information further comprises a type of the Discovery Reference Signal.

5. The method according to claim 1, wherein the primary eNB obtains the OFF-status information from the secondary eNB in any one of:
an X2 Setup Request;
an X2 Setup Response; and
an eNB configuration update; and
the primary eNB transmits the OFF-status information to the UE in measurement configuration information comprising a measurement object which refers to a frequency where the turned-off small cell operates and which comprises the OFF-status information.

6. A method, at a secondary eNB, of measurement enhancement on a turned-off small cell for dual connectivity, the method comprising:
transmitting OFF-status information of the served turned-off small cell to a primary eNB;
receiving a request transmitted from the primary eNB to set up the dual connectivity; and
deciding whether to accept the setting up of the dual connectivity, wherein:
when the setting up of the dual connectivity is accepted:
transmitting an acknowledgement command to the primary eNB, the acknowledgement command comprising configuration information required for a UE to set up the dual connectivity, and
transmitting uplink and downlink data with the UE over the setup dual connectivity; and
when the setting up of the dual connectivity is not accepted, transmitting a failure response to the primary eNB.

7. The method according to claim 6, wherein the turned-off small cell transmits intermittently a Discovery Reference Signal; and
the OFF-status information comprises a transmission interval of the Discovery Reference Signal.

8. The method according to claim 7, wherein when a macro cell served by the primary eNB is not synchronized with the turned-off small cell, the OFF-status information further comprises a difference in synchronization between the macro cell and the turned-off small cell.

9. The method according to claim 6, wherein:
the OFF-status information further comprises a sub-frame number in which the Discovery Reference Signal is transmitted from the turned-off small cell, or a radio frame number and a sub-frame number in which the Discovery Reference Signal is transmitted from the turned-off small cell; and
when the Discovery Reference Signal transmitted from the turned-off small cell is not a Cell-specific Reference Signal, the OFF-status information further comprises a type of the Discovery Reference Signal.

10. The method according to claim 6, wherein the turned-off small cell is a special small cell which refers to a small cell configuring the UE with a PUCCH channel, and when the special small cell is turned off, the transmitting uplink and downlink data with the UE over the setup dual connectivity comprises:
when there is downlink data to transmit to the UE:
turning on the turned-off small cell and transmitting periodically physical layer control signaling to the UE, and
transmitting the downlink data to the UE;
when there is uplink data to receive from the UE, receiving the uplink data of the UE in a random access procedure initiated by the UE over a random access resource configured by the small cell.

11. A method, at a UE, of measurement enhancement on a turned-off small cell for dual connectivity, the method comprising:
setting up an RRC connection with a primary eNB;
receiving OFF-status information of the turned-off small cell from the primary eNB;
measuring a quality of signal of the turned-off small cell based upon the OFF-status information;
transmitting a measurement report about the turned-off small cell to the primary eNB;
receiving RRC connection reconfiguration information from the primary eNB;
reconfiguring the RRC connection according to the RRC connection reconfiguration information to set, up the dual connectivity; and
transmitting uplink and downlink data with a secondary eNB serving the small cell over the setup dual connectivity.

12. The method according to claim 11, wherein the turned-off small cell transmits intermittently a Discovery Reference Signal, and
the OFF-status information comprises a transmission interval of the Discovery Reference Signal; and
when a macro cell served by the primary eNB is not synchronized with the turned-off small cell, the OFF-status information further comprises a difference in synchronization between the macro cell and the turned-off small cell.

13. The method according to claim 11, wherein:
the OFF-status information further comprises a sub-frame number in which the Discovery Reference Signal is transmitted from the turned-off small cell, or a radio frame number and a sub-frame number in which the Discovery Reference Signal (DRS) is transmitted from the turned-off small cell; and
when the Discovery Reference Signal transmitted from the turned-off small cell is not a Cell-specific Reference Signal, the OFF-status information further comprises a type of the Discovery Reference Signal.

14. The method according to claim 13, wherein the turned-off small cell is a special small cell which refers to a small cell configuring the UE with a PUCCH channel, and when the special small cell is turned off, the transmitting uplink and downlink data with a secondary eNB serving the small cell over the setup dual connectivity comprises:
detecting periodically physical layer control signaling from the special small cell, and when the physical layer control signaling is determined to be valid, receiving downlink data transmitted from the secondary eNB; and
when there is uplink data to transmit to the secondary eNB, initiating a random access procedure to the secondary eNB over the setup dual connectivity to transmit the uplink data.

15. A method, at a UE, of measurement enhancement on a turned-off small cell, the method comprising:
receiving measurement configuration information transmitted from an eNB, wherein the measurement configuration information comprises at least a transmission interval of a Discovery Reference Signal transmitted from the turned-off small cell;
measuring and evaluating a quality of signal of the turned-off small cell according to the measurement configuration information; and
when the quality of signal satisfies a report condition, transmitting a measurement report to the eNB about the turned-off small cell.
